(19) United States
(12) Patent Application Publication
(10) Pub. No.: US 2002/0156728 A1
(43) Pub. Date: Oct. 24, 2002

(54) Method and arrangement for the transmission of an electronic sum of money from a credit reserve by wap

(76) Inventors: Rainer Jaschhof, Gernlinden (DE); Hans-Hermann Wolf, Muenchen (DE)

Correspondence Address: BELL, BOYD & LLOYD, LLC, P. O. BOX 1135, CHICAGO, IL, 60690-1135, US

(21) Appl. No.: 10/110,991

(22) PCT Filed: Aug. 2, 2001
(86) PCT No.: PCT/EP01/09216

(30) Foreign Application Priority Data
Aug. 18, 2000 (EP) 00117810.2

(51) Int. Cl. G06F 17/60

(52) U.S. Cl. 705/39

(57) ABSTRACT

Method for transferring an electronic sum of money from a credit memory associated with a money sender to an account or to a credit memory associated with a money receiver via a mobile radio and IP network in real time using the WAP.

The invention relates to a method and to an arrangement for transferring an electronic sum of money from a credit memory to an account or to another credit memory via a mobile radio and data network.

Besides for use as a means of communication and a source of information for what has now become hundreds of millions of people, the Internet is becoming increasingly important as a source of shopping. Particularly trade in software, books and travel is already being carried out on the Internet in a significant proportion today, but also a broad spectrum of other goods and services is increasingly being ordered and paid for over the Internet. Paying for the relevant services on the Internet in the manner which was established originally and is still generally widespread today requires the relevant data records to be input separately in each case, at least by each party to the transaction, if not even for the individual transaction. This mode of payment thus allows the party to the transaction to see sensitive personal data and even to store them permanently.

The Internet has now also become considerably important for handling other payment operations in the business and private sectors. Virtually all banks in industrial states offer electronic handling of account management and of payment operations in the form of “electronic banking”.

Nevertheless, the majority of payment operations in day-to-day life are, even today, still performed using cash or by providing transfer or direct debit orders or the like in writing, or by credit card or check card. In specific areas, for example that of mobile radio technology, electronic credits (“prepaid cards”) have also become significant, but considerable obstacles prevent this from being introduced on a widespread basis as a means of payment for goods other than call time.

Altogether, it can be stated that, in the current state of development, there are an extremely confusing large number of options for paying for goods or services, and using said options in day-to-day life requires considerable alertness and requires a wide variety of media and modes of entry to be dealt with. This is demanding and is also associated with diverse security risks (losing data media or credit media, forgetting account data and authentication codes etc.).

Besides the Internet, telecommunications—in particular mobile telecommunications—today represents an area of rapid technical and economic development and a significant source of economic growth and new social developments. For many of the people in industrial states, the mobile telephone (“mobile”) is increasingly becoming a universal communication and information instrument and is also increasingly being used to access goods and services. This development is also still hindered by insufficient opportunities for reliable and at the same time simple payment for information, goods and services ordered using a mobile.

Although solutions exist which allow the user of a mobile—with or without a prepaid card—to authorize payments, which are then processed in a conventional manner by debit procedures or credit card debiting, these methods presuppose, as do payment processing procedures which have now been introduced on the Internet, that the purchaser is creditworthy and has authority to use a credit card or a current account with an overdraft facility. In addition, these procedures have inherent time lags which have an adverse effect on the transparency and reliability of the overall processing.

The invention is therefore based on the object of specifying a method and an arrangement for simplified processing of payment transactions using a data network.

This object is achieved in terms of its method aspect by a method having the features of claim 1, and in terms of its apparatus aspect by an arrangement having the features of claim 10.

The invention encompasses the fundamental concept of specifying a largely universal payment method on the basis of an electronic credit (prepaid account or card) which can be used for payment processing in the “B2C (Business-2-Consumer) sector” and also in the “C2C (Consumer-2-Consumer) sector”, that is to say allows shopping in real and virtual shops, payment in catering or cultural establishments or at cash machines, etc., and the “transfer” of sums of money in the private sector. It also encompasses the concept of using the opportunities of a combined mobile radio and IP network (specifically the Internet) in this regard, specifically the opportunity for processing in real time, in particular.

In the present case, an electronic credit is understood to mean a memory content of a credit memory which can be operated via a telecommunications or data network in order to perform payment transactions—in principle regardless of whether the memory actually has a prepaid credit or whether a credit sum is not transferred until a later time. In the description below and in the patent claims, the holder of the prepaid credit who wishes to transfer a sum of money and is in a (real or virtual) shop as a purchaser and in a catering establishment as a guest is referred to generally as the “money sender”. The receiver of the sum of money to be transferred, who will usually be the owner or operator of a shop or of a catering or cultural establishment or the like in daily life, is referred to generally as the “money receiver” below. In addition, the money receiver and the money sender may also be applications.

The central piece in the proposed arrangement and in the proposed method is a transaction server in the IP network which accesses a transaction database storing the data relevant for transferring prepaid credits. The transfer operation is initiated by the money sender or money receiver connecting to the transaction server, specifically using its IP network address or using its logical name.

The sum of money to be transferred is input by the money sender or receiver on his respective terminal.

This can also be done in the second phase of a procedure in which the IP network address of the server is first input and dialed and the money sender or receiver is asked by means of menu guidance to input the sum of money. He then makes the relevant input in response to this request.

This application is preferably used within the scope of a subscription by the money receiver. In this context, the money receiver will normally specify a bank account to which the money transferred to his electronic credit memory within the scope of the prepaid shopping application is ultimately transferred. The transaction currency can also be specified. The money sender does not need to take out a subscription for the money transfer procedure. For security reasons, however, it is preferable for the money transfer to be authorized using predetermined authentication means; in this regard, see below.

The preferred subscription to the service by the money receiver is likewise not absolutely necessary. With no formal subscription, however, it is not possible to specify any bank details, which means that the sum of money transferred to the electronic credit memory (“prepaid account”) cannot be transferred further. Since, however, a currency can be specified while the sum is being input, the application is not limited to the currency which is valid in the country of the money sender or receiver. In this form, the method is particularly suitable for the transfer of money between private persons (“C2C”).

When the connection or connections have been set up to the transaction server, the necessary inputs and outputs are [lacuna], preferably in the form of inputs based on based on the WAP (Wireless Application Protocol) and, in future, also based on the HTTP (Hyper Text Transfer Protocol) or on other future transfer protocols.

The aforementioned subscription process involves a data record relating to the money receiver being stored in the transaction database (“shopping database”). The money receiver's account needs to be suitable for the management of electronic credits; it can likewise be a prepaid account, in particular. The money receiver can use a plurality of subscriber IDs and also a plurality of destination accounts for the transfer of money, in which case all the subscriber IDs to be used and account identifiers for all the accounts naturally need to be stored in the shopping database. (The term “account identifier” is understood below to mean an account number or an account code and the possibly required server address of an external server on which the account is managed, as a whole.) Besides the aforementioned data, the money receiver data record stored in the transaction database expediently also comprises a name or company name.

Besides the information relating to the money receiver, the shopping database preferably also contains the information about the money sender which is required for performing the money transfer. This money sender data record expediently contains the account number of his prepaid account and, if required, the server address of an external server on which the prepaid credit is managed (also occasionally referred to in the present case as “account identifier” below), advantageously also the server and operator names and, finally, an authentication data record for authenticating larger money transfers at least optionally on a case by case basis. The “address” or “key” used for this data record is a subscriber ID for the money sender.

The money sender data record can also be stored in a separate prepaid database.

A fundamental security component is the aforementioned authentication data record within the money sender data record. The authentication data record comprises, in particular, an authentication code (PIN or the like) and/or biometric data for the money sender (e.g. papillary line or retina pattern), which code and data are used for authorizing money transfers on a case-by-case basis. This code and these data are input on the money sender's terminal or on an input unit associated therewith, are transmitted to the transaction server and are compared there with the corresponding stored data. As a result of the comparison, the transaction is enabled or blocked.

In one preferred implementation of the method the aforementioned authorization steps are not performed for very small sums, but only for sums of money which exceed a predetermined threshold value. This threshold value can advantageously be set and changed by the service provider or the money sender himself.

On the other hand, authentication can be performed by the money sender as the requester with the transaction server, preferably at the start of processing, that is to say before the money receiver's subscriber ID is actually input. The proposed solution comprises the function blocks (1) start the money transfer procedure, (2) debit the money sender and (3) credit the money receiver. These function blocks can be executed on one and the same server or on different servers, which is/are collectively referred to by the term “transaction server”. The server or servers can exist centrally with a service provider or in a plurality of hardware implementations with this service provider or else with a plurality of service providers. The prepaid shopping application has—as already mentioned above—access to a “shopping database” which (according to the specific network and application concept) can likewise be provided centrally at one point, distributed over a plurality of points or else in a plurality of copies at various points.

The method and arrangement are in the simplest form when the money sender's prepaid credit, the money receiver's destination account and the prepaid shopping application itself are managed or operated with one and the same service provider. If this is not the case, clearing (known as such) needs to take place for the money transfer. For this process, the documentation produced for the debiting and crediting process, particularly in the form of “log records”, can be used.

As a real time method, the proposed method affords improved transparency and reliability as compared with known payment processing methods and can also be used, in particular, by people who have not been granted a credit facility. The user need merely have a prepaid credit ensuring sufficient coverage of the envisaged money transfer.

In addition, the proposed system affords the considerable advantage that the electronic money held in a prepaid account can be used not only for paying for a service having a narrow specification (specifically telephone calls), but also in diverse ways for paying for goods, service, information etc. in real or in virtual sales establishments of all kinds.

Prepayment of the credit gives the user strict cost control, and in principle it is not possible to get into debt unintentionally. This means that this method can be used with particular advantage for minors (or else for older people who are no longer in full possession of their mental faculties) as well, for whom there has been no comparable application to date. For paying for goods and services from different suppliers, a plurality of prepaid cards or terminals is no longer required, but rather it is only necessary to store a single server call number.

Advantages and expediencies of the invention can otherwise be found in the subclaims and in the description below of a preferred exemplary embodiment with reference to the figures, in which:

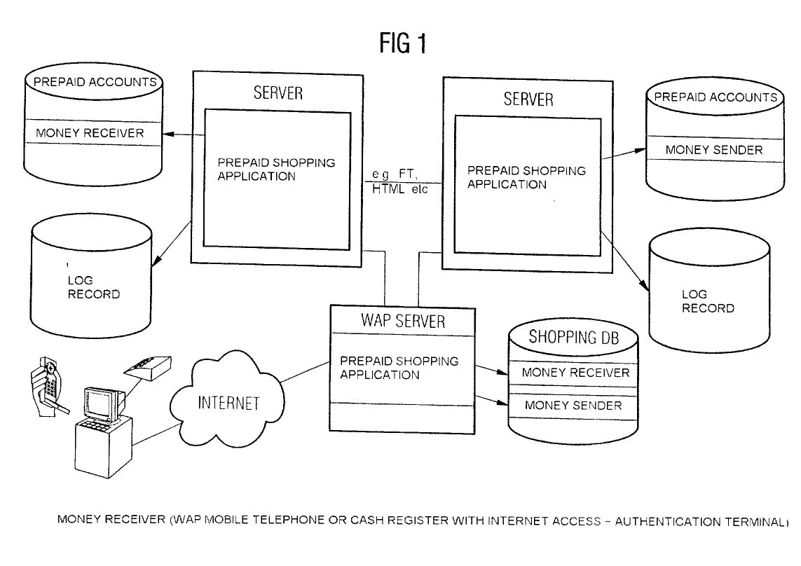

FIG. 1 shows a greatly simplified function block diagram of a first embodiment of the inventive arrangement,

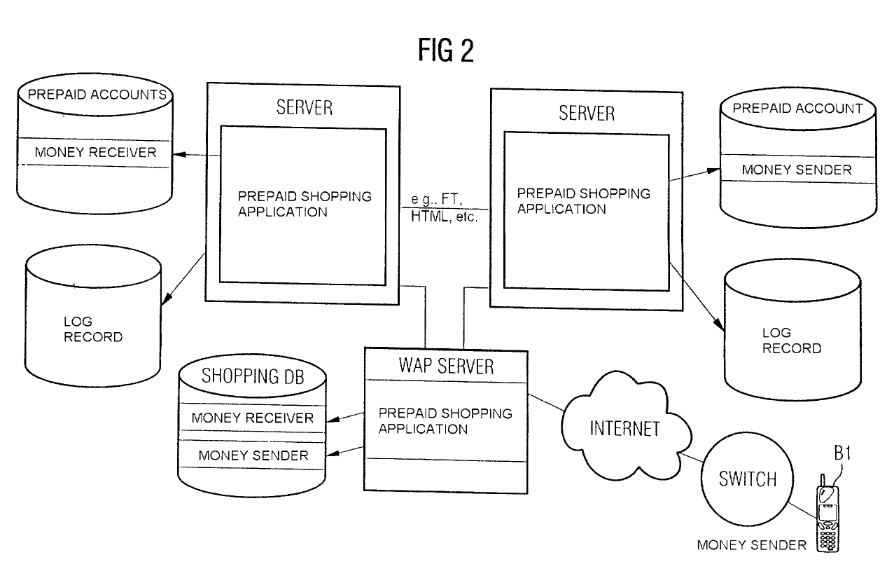

FIG. 2 shows a greatly simplified function block diagram of a second embodiment,

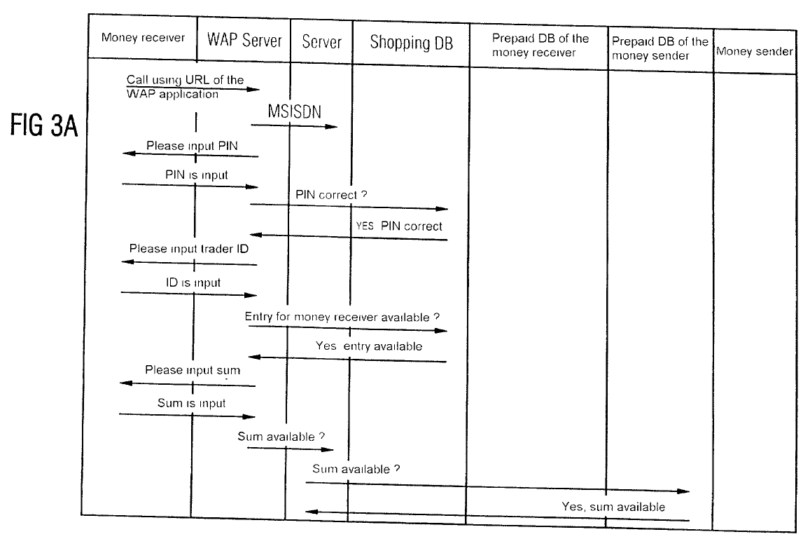

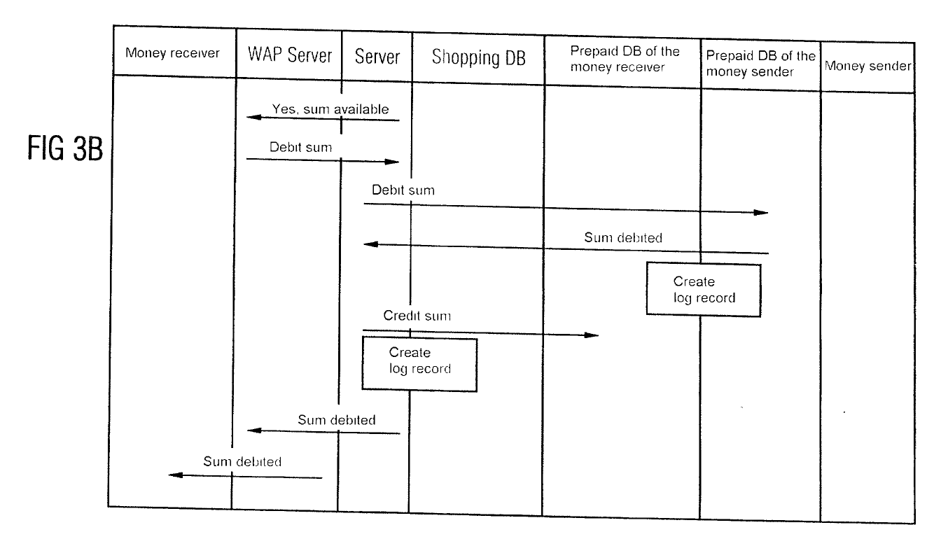

FIGS. 3A and 3B show a schematic illustration of fundamental steps in the proposed application for the arrangement shown in FIG. 1, and

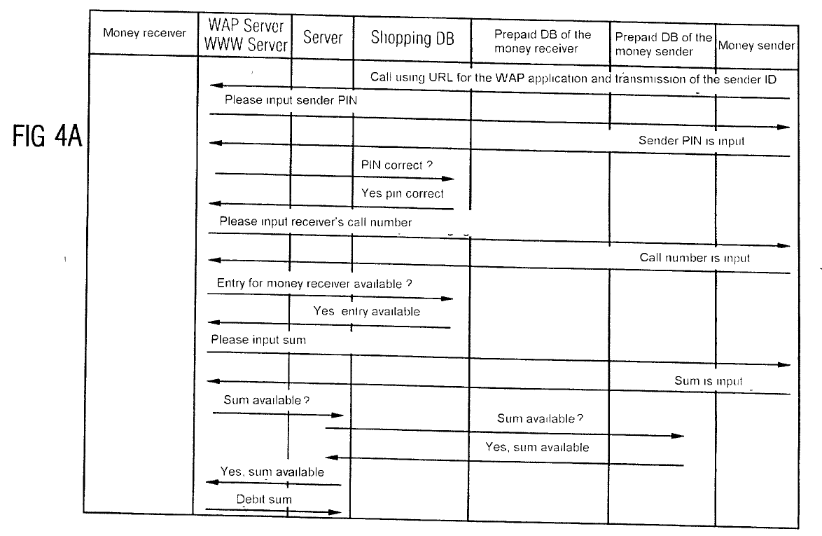

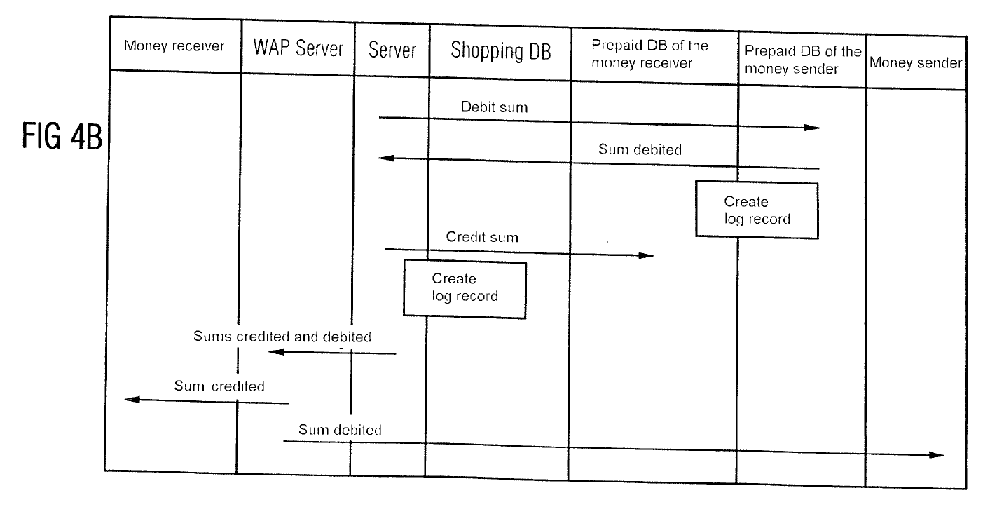

FIGS. 4A and 4B show a schematic illustration of fundamental steps in the proposed application for the arrangement shown in FIG. 2.

The labeling in the figures makes them fundamentally self-explanatory, so that no detailed description of the figures is given below.

FIGS. 1 and 2 respectively show the situation in which the prepaid shopping application and prepaid accounts handled thereby are managed on different servers. FIGS. 3 and 4 show the situation in which the transaction server WAP SERVER is sent a request by the money receiver's terminal (integrated in a complex processing device) and the situation in which the money sender sends a request to the transaction server.

The money transfer process is initiated by the money receiver or money sender sending a request to the transaction server WAP SERVER. In this context, following the server call number—separated therefrom by a star (*)—the sum of money to be transferred is input in the relevant currency as an unstructured digit sequence on the terminal of the money sender or money receiver. This is done using the terminal's keypad, in particular. Provided that the price has not been input in connection with the setup of the connection, the prepaid shopping application starts a text message in the WML format, which asks the calling party to input the price. The caller then inputs the price—for example in a field provided for this purpose on a WAP page.

The prepaid shopping application on the transaction server then transfers the data required for transferring the money (in particular the call numbers of money receiver and money sender and the sum of money) to a prepaid application on a corresponding server. This can be the transaction server itself or at least one server belonging to the same operator or at least one server belonging to another operator. The applications can also run on different servers, having been distributed in modules.

When the data have been transmitted, which means that the money transfer procedure has been started, a checking process is first carried out to determine whether the data medium is valid and whether the sum in the money sender's prepaid account is sufficient for the envisaged transfer process. If both are the case, the money sender is asked (at this point at the latest) to input his PIN in order to authorize the debit operation on the sum of money to be transferred.

The checking process involves the prepaid shopping application accessing the shopping database and reading the money receiver data record and the money sender data record with the information contained therein regarding which server or which servers (and which operator or which operators) hold the accounts of the money receiver and the money sender. The server belonging to the money sender is identified and, if it is a server other than that on which the prepaid shopping application is running, a real time connection to a prepaid shopping application running on this foreign server is set up.

The prepaid shopping application on the money sender's server is sent a request to check whether the electronic credit in the money sender's prepaid account is sufficient for the envisaged money transfer. If this is not the case, the transfer is terminated with corresponding advice in WAP format to the terminal of the money receiver. If the sum of money to be transferred is covered, it is reserved in the money sender's prepaid account. The aforementioned authorization is given by virtue of the money sender inputting the PIN. The PIN which is input is compared with the PIN stored in the money sender data record. If it is valid, the debiting process is initiated. If it is not valid, the transaction is terminated at this point and a corresponding advice signal is again transmitted.

The sum of money to be transferred is then debited from the money sender's prepaid account. This process is time critical and is performed in real time. If the money sender's prepaid account is on the same server as the prepaid shopping application, the credit can immediately (in real time) be reduced by the sum of money to be transferred. If the account is on a foreign server, the debit request needs to be made to the prepaid shopping application on that server, and the debit operation is performed under that application's regime. In each case, a log record is produced for the debiting process, and the money receiver and/or money sender is informed about the debit operation having been performed by means of the cash register system or a call or by SMS or an appropriate WAP page on the display of a mobile telephone or the like.

The sum of money to be transferred is then credited to the money receiver's account, which can be a prepaid account, a real time account or a normal bank current account. This process is not time critical but needs to take place with the utmost reliability. In this case too, a distinction needs to be made between the aforementioned variants for debiting—according to whether or not the account is managed on a foreign server. A log record is also produced for the crediting process.

The implementation of the invention is not limited to the aforementioned examples, variants and aspects; rather, the claims likewise permit a large number of modifications for it which are within the scope of action of a person skilled in the art. In particular, the method steps described above are also possible in a different order.

1. A method for transferring an electronic sum of money from a credit memory associated with a money sender, particularly containing a prepaid credit, to an account or to a credit memory associated with a money receiver via a mobile radio and IP network, in real time, having the following steps:
a money receiver data record, comprising at least one subscriber ID and an account identifier for the money receiver's account or credit memory, is stored in a transaction database and/or in a credit management database, with at least the subscriber ID being stored in the transaction database, particularly within the context of the money receiver's subscription to a money transfer service with a service provider,
a money sender data record, comprising at least one subscriber ID and an account identifier for the credit memory and optionally an authentication data record for the money sender, is stored in the transaction database and/or in a credit management database,
a mobile radio and data network connection is set up between the terminal of the money receiver or money sender, which is in the form of a mobile radio terminal, and a transaction server associated with the service provider using an IP network address for the money transfer service,
the subscriber ID of the respective party to the money transfer and the sum of money to be transferred are input on the terminal of the money receiver or money sender and are transmitted to the transaction server using a common protocol for the mobile radio and IP network, particularly WAP,
the transaction server reads the money receiver data record and, as desired, the money sender data record from the transaction database and evaluates it/them, which includes setting up (an) optionally required data link(s) to one or more external application(s),
the coverage of the sum of money is checked in the money sender credit memory, and the sum of money is reserved if it is covered, or the process is terminated with signaling if there is insufficient coverage,
the sum of money is debited from the money sender credit memory, and this is documented,
the sum of money is credited to the money receiver account or to the money receiver credit memory, and this is documented,
information about the debit and/or credit operation is transmitted to the terminal of the money receiver and/or money sender.

2. The method as claimed in claim 1, characterized in that
the sum of money to be transferred is input in connection with the IP network address or the logical name.

3. The method as claimed in claim 1,
characterized in that
the transaction server generates a request for the input of the sum of money to be transferred and transmits it to the money sender and/or money receiver, and said request is output on the terminal of the money sender and/or money receiver, and
the sum of money is input on the respective terminal in response to this request.

4. The method as claimed in one of the preceding claims,
characterized in that
the IP network address or the logical name of the money transfer service is stored in the mobile radio terminal of the money receiver and/or money sender.

5. The method as claimed in one of the preceding claims,
characterized in that
the authentication data record in the money sender data record comprises an authentication code or biometric data for the money sender, and, before the debit operation step, steps for authorizing said debit operation are performed, namely the following steps:
the authentication code or the biometric data is/are input by the money sender on his terminal,
the input is transmitted to the transaction server, and
the transmitted data are compared with the data held in the money sender data record, and a debit enable signal is output if there is a match and a debit blocking signal is output if there is no match.

6. The method as claimed in claim 5,
characterized in that
the authorization steps are performed for a sum of money which exceeds a predetermined threshold value which can be set by the service provider or the money sender, in particular.

7. The method as claimed in claim 5 or 6,
characterized in that
the authorization steps are performed before the subscriber ID of the party to the money transfer is actually input.

8. The method as claimed in one of the preceding claims,
characterized by
its being performed by setting up a data link to at least one external server on which the money sender credit memory and/or the money receiver account or the money receiver credit memory are managed, the account identifier of the money receiver data record and/or the account identifier of the money sender data record comprising a server address or server call number, and the transaction server being connected to this or these following the step of reading out the money receiver data record and the money sender data record in order to perform the subsequent steps.

9. The method as claimed in one of the preceding claims,
characterized in that
the money receiver takes out a subscription with the service provider using a plurality of accounts and/or subscriber IDs, the number of accounts being less than the number of subscriber IDs, in particular, and all the corresponding account identifiers and the subscriber IDs being stored in the money receiver data record.

10. An arrangement for transferring an electronic sum of money from a credit memory associated with a money sender, particularly containing a prepaid credit, to an account or to a credit memory associated with a money receiver via a mobile radio and IP network in real time, particularly in order to carry out the method as claimed in one of the preceding claims, which has:
at least one account management server having a money sender credit memory and a money receiver account or credit memory,
a money receiver terminal connected to the telecommunications and data network,
a money sender terminal connected to the telecommunications and data network, the terminal of the money receiver and/or money sender being in the form of a mobile radio terminal or having a mobile radio part which is designed to process a common protocol for the mobile radio and IP network, particularly the WAP,
a transaction database associated with a service provider, which stores a money receiver data record, comprising a subscriber ID and/or an account identifier for the account or credit memory of the money receiver, and a money sender data record comprising a subscriber ID and/or an account identifier for the credit memory of the money sender, and optionally an authentication data record, and
a transaction server which is connected to the transaction database and can be connected to the terminals of the money sender and money receiver by means of an IP network address for the money transfer service and to the account management server or account management servers by means of a data link or is an integral part of said server or servers,
for reading and for evaluating the money receiver data record and the money sender data record from the transaction database or from the account management server or account management servers, and for setting up (an) optionally required data link(s) to one or more external application(s) and for controlling a coverage check in the money sender credit memory and a debit operation on the latter and a credit operation on the money receiver account or money receiver credit memory.

11. The arrangement as claimed in claim 10,
characterized in that
the transaction database and the money sender credit memory and/or the money receiver credit memory are implemented on the transaction server.

12. The arrangement as claimed in claim 10 or 11,
characterized in that
the transaction server has means for documenting a debit operation and a credit operation, in particular in the form of a log record.

13. The arrangement as claimed in one of claims 10 to 12,
characterized in that
the transaction server has associated telecommunication means for signaling termination of a transaction or a debit operation and/or a credit operation to the money sender's terminal, particularly using the common protocol of the mobile radio and IP network, especially the WAP.

14. The arrangement as claimed in one claims 10 to 13,
characterized in that
the money receiver's terminal is incorporated in a cash register device or other data processing device.
